(19) United States
(12) Patent Application Publication
(10) Pub. No.: US 2025/0298728 A1
(43) Pub. Date: Sep. 25, 2025

(54) PROCESSING RULE ERROR DETERMINATION

(71) Applicant: Capital One Services, LLC, McLean, VA (US)

(72) Inventors: David ERDNER, The Colony, TX (US); Shailaja MASARWALA, McKinney, TX (US)

(21) Appl. No.: 18/615,016

(22) Filed: Mar. 25, 2024

(51) Int. Cl. G06F 11/36

(52) U.S. Cl. CPC G06F 11/3684; G06F 11/3688

(57) ABSTRACT

In some implementations, a rule evaluation system may receive a data file including a set of processing rules for processing a dataset. The rule evaluation system may extract a set of conditional variables from the set of processing rules. The rule evaluation system may determine a set of possible values for the set of conditional variables. The rule evaluation system may generate a set of test cases, wherein a test case represents a combination of a plurality of values for the set of conditional variables. The rule evaluation system may evaluate, using the set of test cases, the set of processing rules to identify one or more error cases associated with one or more processing rules of the set of processing rules. The rule evaluation system may provide output identifying a result of evaluating the set of processing rules.

### BACKGROUND

A processing system may store one or more data files, which are used for evaluation of data. For example, the processing system may store a data file that includes a set of rules that are to be executed on an input data element to generate an output. In one context, a processing system may use a data file to store rules relating to quality control. For example, the data file may include a set of rules that are executed to indicate whether a manufactured item satisfies quality control standards. In another context, a processing system may use a data file to store rules relating to allocating bandwidth or managing network traffic in a network. In another context, a processing system may use a data file to store rules relating to a transaction, such as rules relating to pricing or loan terms.

### SUMMARY

Some implementations described herein relate to a system for processing rule evaluation. The system may include one or more memories and one or more processors communicatively coupled to the one or more memories. The one or more processors may be configured to receive a data file including a set of processing rules for processing a dataset. The one or more processors may be configured to extract a set of conditional variables from the set of processing rules included in the data file. The one or more processors may be configured to determine a set of possible values for the set of conditional variables. The one or more processors may be configured to generate a set of test cases, wherein a test case, of the set of test cases, represents a combination of a plurality of values, of the set of possible values, for the set of conditional variables. The one or more processors may be configured to evaluate, using the set of test cases, the set of processing rules to identify one or more error cases associated with one or more processing rules of the set of processing rules. The one or more processors may be configured to transmit information identifying the one or more processing rules associated with the one or more error cases.

Some implementations described herein relate to a non-transitory computer-readable medium that stores a set of instructions. The set of instructions, when executed by one or more processors of a system, may cause the system to receive a new processing rule for inclusion in a data file, wherein the data file includes a set of processing rules for processing a dataset. The set of instructions, when executed by one or more processors of the system, may cause the system to extract a set of conditional variables from the set of processing rules included in the data file and the new processing rule. The set of instructions, when executed by one or more processors of the system, may cause the system to determine a set of possible values for the set of conditional variables. The set of instructions, when executed by one or more processors of the system, may cause the system to generate a set of test cases, wherein a test case, of the set of test cases, represents a combination of a plurality of values, of the set of possible values, for the set of conditional variables. The set of instructions, when executed by one or more processors of the system, may cause the system to evaluate, using the set of test cases, the set of processing rules and the new processing rule to identify one or more error cases associated with the new processing rule. The set of instructions, when executed by one or more processors of the system, may cause the system to selectively add the new processing rule to the data file based on evaluating the set of processing rules.

Some implementations described herein relate to a method. The method may include receiving, by a rule evaluation system, a data file including a set of processing rules for processing a dataset. The method may include extracting, by the rule evaluation system, a set of conditional variables from the set of processing rules included in the data file. The method may include determining, by the rule evaluation system, a set of possible values for the set of conditional variables. The method may include generating, by the rule evaluation system, a set of test cases, wherein a test case, of the set of test cases, represents a combination of a plurality of values, of the set of possible values, for the set of conditional variables. The method may include evaluating, by the rule evaluation system and using the set of test cases, the set of processing rules to identify one or more error cases associated with one or more processing rules of the set of processing rules. The method may include providing, by the rule evaluation system, output identifying a result of evaluating the set of processing rules.

### BRIEF DESCRIPTION OF THE DRAWINGS

FIGS. 1A-1D are diagrams of an example implementation associated with processing rule error determination, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with processing rule error determination, in accordance with some embodiments of the present disclosure.

FIG. 4 is a flowchart of an example process associated with processing rule error determination, in accordance with some embodiments of the present disclosure.

### DETAILED DESCRIPTION

The following detailed description of example implementations refers to the accompanying drawings. The same reference numbers in different drawings may identify the same or similar elements.

Some implementations described herein enable detection of error cases in data files used for storing rulesets. As a result, a likelihood of generating errors when using a ruleset to process data is reduced.

A data file, such as a rule file, may store information identifying a set of rules for processing data. For example, the data file may store tens, hundreds, thousands, or millions of rules that can be applied to process an input dataset and identify an action to perform or an output to provide. Examples of contexts for such rule files include quality control for manufacturing (e.g., where a set of rules may be evaluated to determine whether to pass a manufactured item, reject a manufactured item, or perform a particular manufacturing step on the item), healthcare management (e.g., where a set of rules may be evaluated to determine a treatment to provide to a patient), network management (e.g., where a set of rules may be evaluated to allocate bandwidth or prioritize network traffic), or transaction management (e.g., where a set of rules may be evaluated to determining pricing or transaction terms).

Some rule files and associated rulesets may have errors. One source of errors is non-mutual-exclusivity of a ruleset. In other words, a rule file may include two rules that are implicated or executed by a particular input. Accordingly, when the rule file is used to process the particular input, the processing will result in two different actions or outputs being determined. This may result in undesirable ambiguity or unexpected results, such as two different (conflicting) treatments being recommended for a patient, two different communication channels being allocated the same set of resources, two different priorities being assigned to the same communication channel, a manufactured item being both failed and passed for quality control inspection, or two different minimum down payments being required for a loan application. Another source of errors is non-exhaustiveness of a ruleset. In other words, a rule file may not include a rule that covers a possible input. Accordingly, when the rule file is used to process an input, no rule may be implicated or executed for the input, resulting in a failure to perform an action or provide an output. Some testing procedures use training data gathered from actual utilization of a ruleset (e.g., real-life data) to test whether a ruleset has errors; however, real-life data may not cover all possible inputs to a ruleset. Further, use of real-life data may prevent pre-deployment testing (e.g., before real-life data has been generated).

Some implementations described herein provide for ruleset evaluation. For example, an evaluation system may automatically evaluate a data file, such as a rule file, to determine whether an error exists with a set of rules included in the data file or whether addition of a new rule to the data file causes the ruleset to include an error. In some implementations, the evaluation system may identify a set of possible values and combinations thereof for a ruleset and may generate a set of test cases for execution. The evaluation system may execute the set of test cases using the ruleset and determine whether any errors, such as non-mutual-exclusivity errors or non-exhaustiveness errors, are present with the ruleset. Based on evaluating the ruleset, the evaluation system may alter a rule, remove a rule, add a rule, transmit an alert, or perform another action relating to the ruleset. In this way, by automatically generating and executing test cases, the evaluation system avoids use of rules containing errors, thereby improving functioning of a system that uses a ruleset. For example, the evaluation system reduces a likelihood that use of a ruleset will cause a failure to provide an output or perform an action, will cause multiple conflicting outputs to be provided, or will cause multiple conflicting actions to be performed.

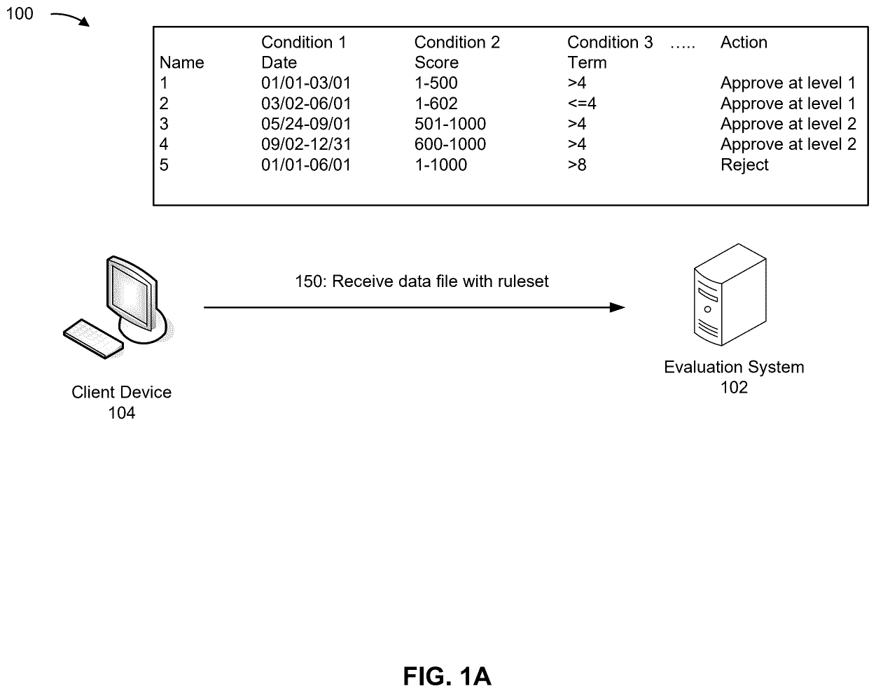

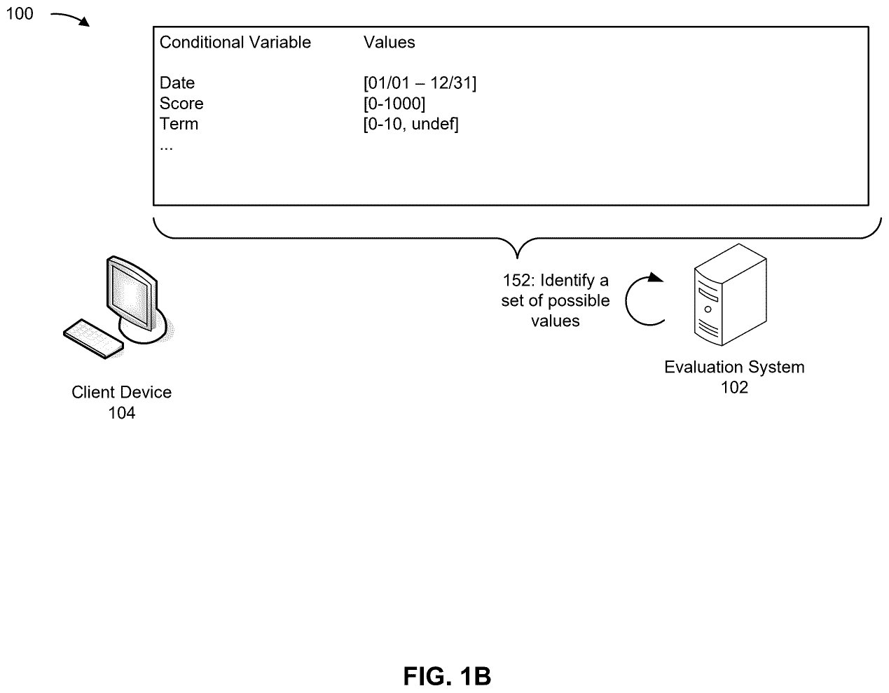

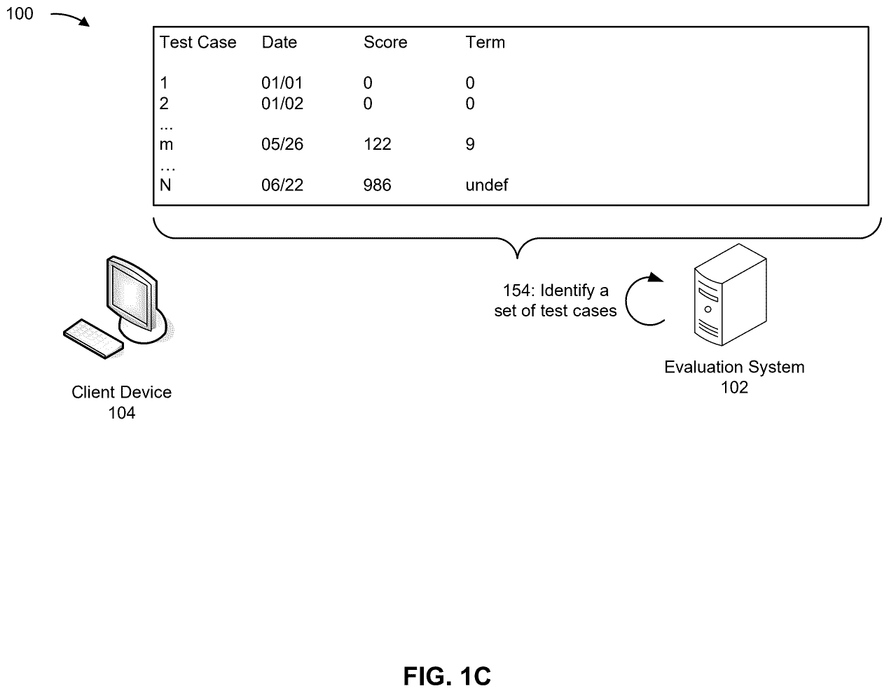

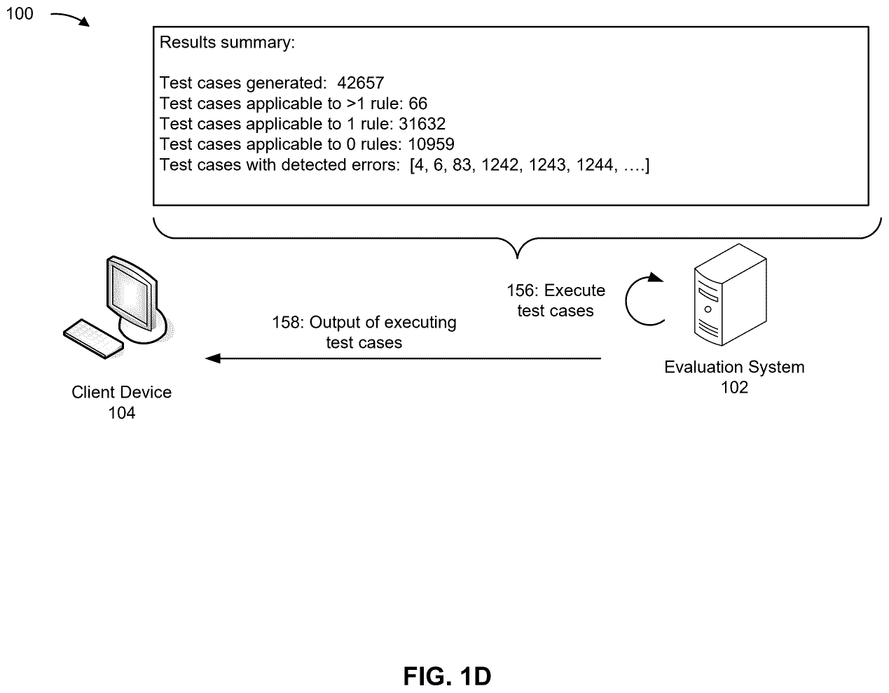

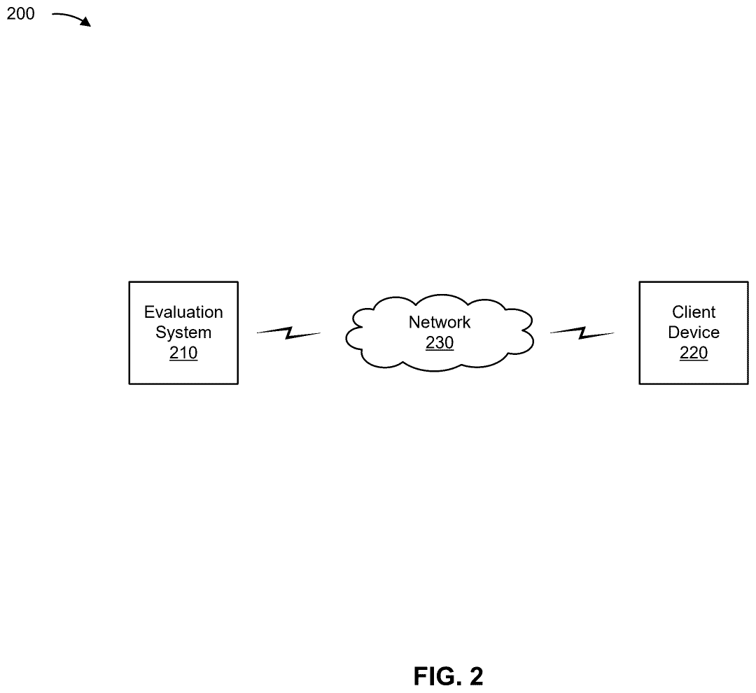

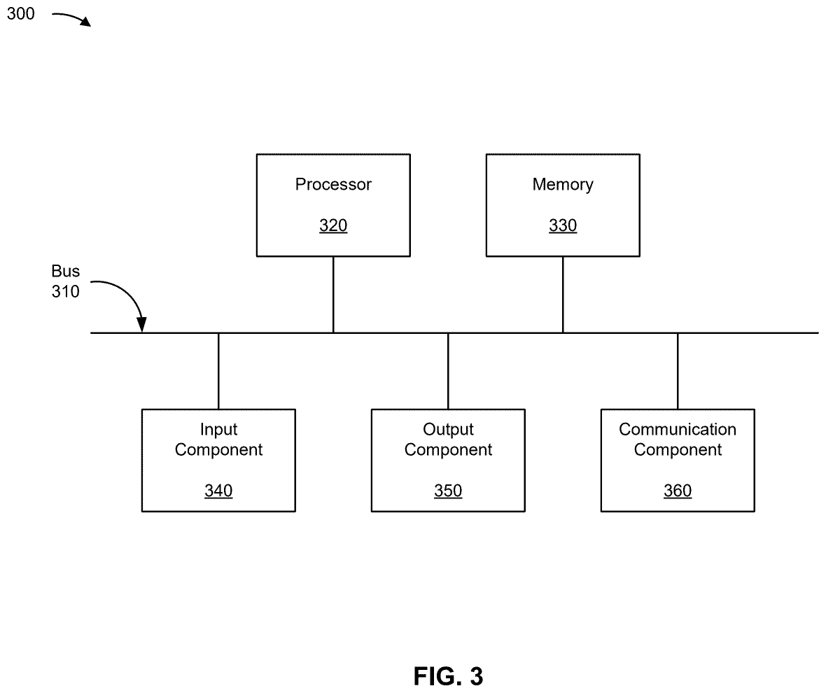

FIGS. 1A-1D are diagrams of an example implementation 100 associated with processing rule error determination. As shown in FIGS. 1A-1D, example implementation 100 includes an evaluation system 102 and a client device 104. These devices are described in more detail below in connection with FIG. 2 and FIG. 3.

As shown in FIG. 1A, and by reference number 150, the evaluation system 102 may receive a data file with a ruleset. For example, the evaluation system 102 may receive, from the client device 104, a rule file that includes a set of rules in a configured format. In some implementations, the data file may be a structured file. For example, the evaluation system 102 may receive a spreadsheet file (e.g., with values stored in a row-column format), a delimited file (e.g., a comma separated value (CSV) file), or an object file (e.g., a JavaScript object notation (JSON) file), among other examples. In this case, the evaluation system 102 may determine the set of rules in the data file by parsing the data file. For example, the evaluation system 102 may parse the data file to identify a group of conditional variables and a set of rules that use one or more of the group of conditional variables.

As a particular example, a first rule may have a first conditional variable relating to a date (e.g., of a submission of data via a web form), a second conditional variable relating to a score (e.g., a provided score in the submission of data or a determined score based on the submission of data), and a third conditional variable relating to a term (e.g., an amount of time indicated in the submission of data). Additionally, or alternatively, the first rule may be associated with an action or output that is to be triggered based on the submission of data satisfying criteria of the conditional variables. For example, the first rule may have an action relating to approving the submission of data at a first level. Other rules may have actions relating to approving the submission of data at a second level or rejecting the submission of data, as described in more detail herein.

In some implementations, the evaluation system 102 may receive a data file for testing of a set of rules in the data file. For example, the evaluation system 102 may receive a request to test the data file to determine whether any errors are detected for any rules stored in the data file. Additionally, or alternatively, the evaluation system 102 may receive a rule for testing before inclusion in a data file. In other words, the evaluation system 102 may receive first information identifying a data file with a set of rules and second information identifying a new rule for inclusion in the data file. In this case, the evaluation system 102 may receive a request to determine whether an error is detected for the data file based on inclusion of the new rule in the data file.

As shown in FIG. 1B, and by reference number 152, the evaluation system 102 may identify a set of possible values. For example, the evaluation system 102 may parse a set of rules of the data file to determine the set of possible values for the set of rules. In some implementations, the evaluation system 102 may identify a range of values for each conditional variable associated with the set of rules. For example, when the evaluation system 102 identifies a first conditional variable relating to a day and month, the evaluation system 102 may identify possible values as any possible valid day and month. In some implementations, when an evaluation request includes a request for invalid submission handling, the evaluation system 102 may identify one or more possible values that are invalid, such as an invalid day or month or an invalid format for a day or month. In another example, the evaluation system 102 may identify a range of values for a conditional variable based on a data type. For example, when the evaluation system 102 determines that a conditional variable for a score accepts a 6-bit integer as an input, the evaluation system 102 may determine the range of values as being all possible 6-bit integers that can be received in the data submission. Additionally, or alternatively, the evaluation system 102 may receive an indication of a valid range of submissions, such as an indication that the score conditional variable can include submissions in a range of 1-1000 or an indication that the term conditional variable can include submissions in a range 1 to 10.

In some implementations, the evaluation system 102 may identify an open-ended range or another type of range without a finite set of values. For example, the evaluation system 102 may determine that a conditional variable may include any positive number. In this case, the evaluation system 102 may have a configured logic for selecting a range of possible values to use for a finite quantity of test cases. For example, the evaluation system 102 may have an algorithm for selecting test values or a maximum test value for an infinite set of possible values for a range of a conditional variable.

In some implementations, the evaluation system 102 may identify one or more values based on receiving a message identifying one or more values. For example, the evaluation system 102 may receive, from a client device 104, a set of user selected values for inclusion in a set of test cases. In this case, a user may select one or more specific expected or error case values with which to test a rule-file using the evaluation system. Additionally, or alternatively, when a rule includes a blank value for a given condition, such that the rule evaluates to true for any non-null input to the rule, the evaluation system 102 may receive or generate one or more values that are not derived from a possible range of values. In some implementations, the evaluation system 102 may receive one or more values via a CSV file, a JSON file, or another type of representation of, for example, a key value pair.

In some implementations, the evaluation system 102 may determine all possible combinations of possible values. For example, for a row and column formatted rule-file, as shown, the evaluation system 102 may determine all possible combinations of unique column values by determining a list product of the set of ranges of values for each conditional variable associated with each column. In some implementations, the evaluation system 102 may generate combinations of possible values on a row-by-row basis. For example, for a single row, the evaluation system 102 may determine a set of possible combinations of values and add the set of possible combinations of values to a list. In this case, the evaluation system 102 may proceed with generating a new set of possible combinations of values for each row and adding the new sets of possible combinations of values to the list. In this case, the evaluation system 102 may perform a deduplication procedure at a list level (e.g., from the list of possible combinations of values) to remove duplicative possible combinations of values generated from different rows from the list. In some implementations, the evaluation system 102 may generate combinations of possible values on a column-by-column basis. For example, the evaluation system 102 may identify all possible values for each column and generate a set of possible combinations of values for multiple columns based on the possible values for each column. In this case, the evaluation system 102 performs the deduplication procedure at a column level (e.g., before generating the list of possible combinations of values.

In some implementations, the evaluation system 102 may remove a set of conflicting combinations of possible values from the set of possible values. For example, the evaluation system 102 may determine that a first conditional variable for a month includes values of 1 to 12 and a second conditional variable for a day includes values of 1 to 31. In this case, the evaluation system 102 may determine a relationship between the first conditional variable and the second conditional variable (e.g., that each month has a particular quantity of days and that some months have fewer than 31 days). Accordingly, the evaluation system 102 may determine that some combinations of values (e.g., [02 30] representing an invalid date “February 30”) are invalid and may remove such combinations of values from a list of combinations of possible values.

As shown in FIG. 1C, and by reference number 154, the evaluation system 102 may identify a set of test cases. For example, the evaluation system 102 may generate a test script with a set of test cases for testing the set of rules included in the data file. In some implementations, the evaluation system 102 may generate the set of test cases using the set of possible combinations of values. For example, the evaluation system 102 may generate a test case for each possible combination of values to test whether each possible combination of values triggers a rule of the data file. Additionally, or alternatively, the evaluation system 102 may use a sampling procedure to reduce a quantity of test cases. For example, the evaluation system 102 may remove a subset of test cases to reduce a quantity of test cases that are to be executed. Additionally, or alternatively, the evaluation system 102 may use a splitting procedure to split the set of test cases. For example, the evaluation system 102 may assign different test cases to different groups of test cases that can be executed separately (e.g., in parallel). For example, the evaluation system 102 may identify a binary variable and split a set of test cases, such that a first group includes a first value for the binary variable and a second group includes a second value for the binary variable. In this case, the evaluation system 102 may generate multiple sub-files to divide a data file for separate processing.

Additionally, or alternatively, by dividing the data files into sub-files, the evaluation system 102 may reduce a quantity of combinations of possible values associated with each sub-file (relative to the parent file), which may improve processing relative to determining combinations of possible values for an entire rule-set. In some implementations, the evaluation system 102 may determine whether to divide a data file for separate processing based on a size of the data file, a quantity of rules in the rule-set, a quantity of conditional variables, a quantity of test cases, or a quantity of possible combinations of values. For example, when a quantity of test cases exceeds a threshold, the evaluation system 102 may split a data file into multiple sub-files with corresponding sets of test cases. In this case, the evaluation system 102 may recombine results of executing the sets of test cases on the multiple sub-files to generate a set of results for the data file.

As shown in FIG. 1D, and by reference number 156, the evaluation system 102 may execute the set of test cases. For example, the evaluation system 102 may execute the set of test cases on the data file to determine a set of results. In some implementations, the evaluation system 102 may execute the set of test cases sequentially. For example, the evaluation system 102 may evaluate each combination of possible values sequentially or concurrently to identify one or more rules that are satisfied by each combination of possible values. In other words, the evaluation system 102 may determine that a particular date, score, and term satisfies a particular rule (resulting in an action of the particular rule being triggered).

In some implementations, to execute the set of test cases, the evaluation system 102 may read in a test case. For example, the evaluation system 102 may read in a combination of values of a test case and insert the combination of values of the test case into a set of conditional variables of a rule. The evaluation system 102 may determine, for each rule, whether the combination of values satisfies the rule (and triggers an action of the rule). In other words, the evaluation system 102 may determine whether each conditional variable of a rule evaluates to a true state when a corresponding value of a test case is inserted. In this case, when the combination of values satisfies the rule, the evaluation system 102 may store information identifying the rule that the test case has triggered. Further, the evaluation system 102 may determine whether any other rules of the rule-set are satisfied by the combination of values. In other words, the evaluation system 102 may store information identifying whether multiple rules are satisfied by a combination of values. In this case, the evaluation system 102 may determine that a combination of values results in an ambiguous output. For example, when the rule-set is associated with determining whether to pass or fail a manufacture item for quality control, and when a first rule is triggered that passes the manufacture item and a second rule is triggered that fails the manufacture item, the evaluation system 102 may determine that the rule-set is not mutually exclusive. Additionally, or alternatively, the evaluation system 102 may store information identifying whether no rules are satisfied by a combination of values. For example, when the rule-set is associated with generating an output of a loan rate based on a set of factors, and when no rule (e.g., for generating the loan rate) is triggered by a combination of values, the evaluation system 102 may determine that the rule-set is not exhaustive.

In some implementations, the evaluation system 102 may evaluate the set of rules with respect to a prioritization. For example, the evaluation system 102 may order the set of rules in accordance with a prioritization of the set of rules. In this case, when the evaluation system 102 determines that each time a test case satisfies conditional variables of a lower priority rule the test case also satisfies conditional variables of a higher priority rule, the evaluation system 102 may determine that the lower priority rule is redundant with respect to the higher priority rule. In some implementations, the evaluation system 102 may evaluate an ordering of the rule-set. For example, when rules of the rule-set are configured to be executed sequentially until a rule is triggered, but a lower priority rule (which can be triggered by the same combination of values as a higher priority rule) is positioned before the higher priority rule in a list, the evaluation system 102 may determine that there is an ordering error with the rule-set.

In some implementations, the evaluation system 102 may evaluate the set of rules with respect to actions performed or triggered by the set of rules. For example, the evaluation system 102 may determine which actions are performed as a result of executing one or more test cases and may determine whether any possible actions are not performed as a result of executing any test cases. Additionally, or alternatively, the evaluation system 102 may determine whether multiple actions are performed as a result of executing a single test case or set of test cases. For example, the evaluation system 102 may determine how many and which actions are triggered for a single test case.

As further shown in FIG. 1D, and by reference number 158, the evaluation system 102 may transmit an output of executing the set of test cases. For example, the evaluation system 102 may transmit, to the client device 104, information identifying a result of executing the set of test cases. In some implementations, the evaluation system 102 may transmit information identifying one or more metrics relating to executing the set of test cases. For example, the evaluation system 102 may transmit information identifying a quantity of test cases, a quantity of test cases that trigger more than one rule, a quantity of test cases that trigger exactly one rule, or a quantity of test cases that are not triggered by any rules. Additionally, or alternatively, the evaluation system 102 may transmit information indicating what percentage of test cases are triggered by each rule or what percentage of test cases with a particular value for a particular conditional variable are triggered for each rule. Additionally, or alternatively, the evaluation system 102 may transmit information identifying how many test cases triggered each rule when including or excluding a prioritization of a particular rule. Additionally, or alternatively, the evaluation system 102 may transmit information how many test cases triggered each rule with other possible prioritizations for a particular rule. Additionally, or alternatively, the evaluation system 102 may determine and transmit information identifying rules that have a threshold correspondence with respect to prioritization. For example, the evaluation system 102 may determine a first rule with a higher priority than a second rule, and which is being triggered more frequently than the second rule as a result of the higher priority.

Additionally, or alternatively, the evaluation system 102 may transmit information identifying one or more error cases associated with the set of test cases. For example, the evaluation system 102 may transmit information identifying one or more test cases with detected error cases as a result of, for example, triggering multiple rules or not triggering any rules. Similarly, the evaluation system 102 may transmit information identifying one or more rules associated with detected error cases as a result of, for example, being triggered by the same test case as another rule or never being triggered by any test case.

In some implementations, the evaluation system 102 may automatically resolve one or more errors. For example, the evaluation system 102 may remove a rule that is determined to be redundant with respect to another rule (e.g., a first rule that is only triggered when a second rule is also triggered). In this way, the evaluation system 102 may generate a new data file with a reduced amount of data in a rule-set relative to an original data file, thereby reducing data storage requirements associated with the ruleset and/or processing requirements associated with using the ruleset. Additionally, or alternatively, the evaluation system 102 may modify a rule by changing an order of the rule (e.g., to resolve an ordering error). Additionally, or alternatively, the evaluation system 102 may modify a rule by changing one or more parameters (e.g., one or more conditional variables) to avoid a non-mutual-exclusivity error or to resolve an exhaustiveness error.

In some implementations, the evaluation system 102 may determine whether to deploy a rule or ruleset. For example, the evaluation system 102 may determine that there are no errors with a rule-set and may deploy the ruleset from a testing environment associated with the evaluation system 102 to a production environment in which the ruleset can be accessed (e.g., by the client device 104). Additionally, or alternatively, the evaluation system 102 may determine whether to add a new rule to the ruleset. For example, the evaluation system 102 may determine that there is not an error associated with a new rule under testing and may determine to add the new rule to the ruleset.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include an evaluation system 210, a client device 220, and a network 230. Devices of environment 200 may interconnect via wired connections, wireless connections, or a combination of wired and wireless connections.

The evaluation system 210 may include one or more devices capable of receiving, generating, storing, processing, providing, and/or routing information associated with processing rule error determination, as described elsewhere herein. The evaluation system 210 may include a communication device and/or a computing device. For example, the evaluation system 210 may include a server, such as an application server, a client server, a web server, a database server, a host server, a proxy server, a virtual server (e.g., executing on computing hardware), or a server in a cloud computing system. In some implementations, the evaluation system 210 may include computing hardware used in a cloud computing environment. In some implementations, the evaluation system 210 may correspond to the evaluation system 102 described in connection with FIGS. 1A-1D.

The client device 220 may include one or more devices capable of receiving, generating, storing, processing, and/or providing information associated with processing rule error determination, as described elsewhere herein. The client device 220 may include a communication device and/or a computing device. For example, the client device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the client device 220 may correspond to the client device 104 described in connection with FIGS. 1A-1D.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with processing rule error determination. The device 300 may correspond to the evaluation system 210 and/or the client device 220. In some implementations, the evaluation system 210 and/or the client device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

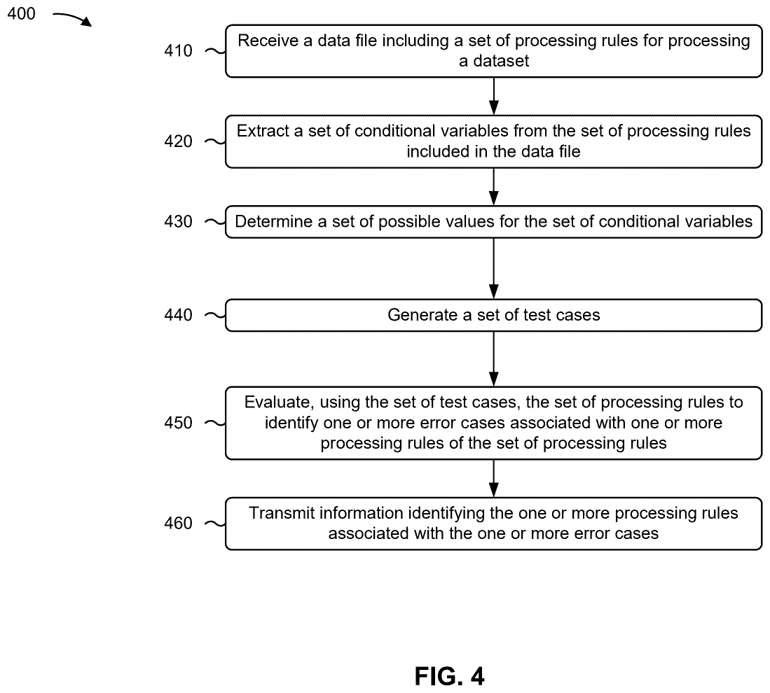

FIG. 4 is a flowchart of an example process 400 associated with processing rule error determination. In some implementations, one or more process blocks of FIG. 4 may be performed by the evaluation system 210. In some implementations, one or more process blocks of FIG. 4 may be performed by another device or a group of devices separate from or including the evaluation system 210, such as the client device 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a data file including a set of processing rules for processing a dataset (block 410). For example, the evaluation system 210 (e.g., using processor 320, memory 330, input component 340, and/or communication component 360) may receive a data file including a set of processing rules for processing a dataset, as described above in connection with reference number 150 of FIG. 1A. As an example, the evaluation system 210 may receive a rule file in a particular format and the rule file may include structured information, such as a set of rules that are used for processing data and generating an output from the data.

As further shown in FIG. 4, process 400 may include extracting a set of conditional variables from the set of processing rules included in the data file (block 420). For example, the evaluation system 210 (e.g., using processor 320 and/or memory 330) may extract a set of conditional variables from the set of processing rules included in the data file, as described above in connection with reference number 152 of FIG. 1B. As an example, the evaluation system 210 may read the rule file to determine a set of conditional variables that can have values for rules of the rule file.

As further shown in FIG. 4, process 400 may include determining a set of possible values for the set of conditional variables (block 430). For example, the evaluation system 210 (e.g., using processor 320 and/or memory 330) may determine a set of possible values for the set of conditional variables, as described above in connection with reference number 152 of FIG. 1B. As an example, the evaluation system 210 may read each row of a rule file and, for each column in each row, add one or more values to a list representing all possible values for each condition variable of a set of conditional variables. In some implementations, the evaluation system 210 may identify a set of combinations of values that are possible for the set of conditional variables. For example, the evaluation system 210 may determine that a first conditional variable can have a first range of values and a second conditional variable can have a second range of values, resulting in a combination of values being a combination of each value of the first range of values and each value of the second range of values.

As further shown in FIG. 4, process 400 may include generating a set of test cases, wherein a test case, of the set of test cases, represents a combination of a plurality of values, of the set of possible values, for the set of conditional variables (block 440). For example, the evaluation system 210 (e.g., using processor 320 and/or memory 330) may generate a set of test cases, wherein a test case, of the set of test cases, represents a combination of a plurality of values, of the set of possible values, for the set of conditional variables, as described above in connection with reference number 154 of FIG. 1C. As an example, the evaluation system 210 may generate a test case for each combination of possible values. In some implementations, the evaluation system 210 may prune the set of test cases to avoid duplicative or redundant test cases. For example, the evaluation system 210 may determine that a first value is mutually exclusive from a second value and may remove combinations of values that include both the first value and the second value.

As further shown in FIG. 4, process 400 may include evaluating, using the set of test cases, the set of processing rules to identify one or more error cases associated with one or more processing rules of the set of processing rules (block 450). For example, the evaluation system 210 (e.g., using processor 320 and/or memory 330) may evaluate, using the set of test cases, the set of processing rules to identify one or more error cases associated with one or more processing rules of the set of processing rules, as described above in connection with reference number 156 of FIG. 1D. As an example, the evaluation system 210 may execute the set of test cases sequentially or with parallel processing to generate a set of results for the set of test cases.

As further shown in FIG. 4, process 400 may include transmitting information identifying the one or more processing rules associated with the one or more error cases (block 460). For example, the evaluation system 210 (e.g., using processor 320, memory 330, and/or communication component 360) may transmit information identifying the one or more processing rules associated with the one or more error cases, as described above in connection with reference number 158 of FIG. 1D. As an example, the evaluation system 210 may transmit information identifying an output, such as a quantity of detected errors, a quantity of test cases that invoked multiple rules, a quantity of test cases that invoked a single rule, or a quantity of test cases that did not invoke any rules.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for processing rule evaluation, the system comprising:
one or more memories; and
one or more processors, communicatively coupled to the one or more memories, configured to:
receive a data file including a set of processing rules for processing a dataset;
extract a set of conditional variables from the set of processing rules included in the data file;
determine a set of possible values for the set of conditional variables;
generate a set of test cases, wherein a test case, of the set of test cases, represents a combination of a plurality of values, of the set of possible values, for the set of conditional variables;
evaluate, using the set of test cases, the set of processing rules to identify one or more error cases associated with one or more processing rules of the set of processing rules; and
transmit information identifying the one or more processing rules associated with the one or more error cases.

2. The system of claim 1, wherein the one or more processors, to evaluate the set of processing rules, are configured to:
insert, for a particular test case of the set of test cases, a particular set of values associated with the particular test case;
identify, for the set of processing rules, a subset of processing rules for which the particular set of values are applicable; and
store, for the subset of processing rules, an indicator that the particular test case included the particular set of values that are applicable to the subset of processing rules.

3. The system of claim 1, wherein the one or more processors, to evaluate the set of processing rules, are configured to:
detect an error case, of the one or more error cases, based on a quantity of instances of a particular processing rule, of the one or more processing rules, being executed satisfying a threshold.

4. The system of claim 1, wherein the one or more processors, to transmit information identifying the one or more processing rules, are configured to:
remove the one or more processing rules from the data file to generate a new data file; and
transmit the new data file.

5. The system of claim 1, wherein the one or more processors, to evaluate the set of processing rules, are configured to:
determine that a group of one or more values, of the set of possible values, is applicable to both a first processing rule, of the set of processing rules, and a second processing rule, of the set of processing rules; and
detect an error case, of the one or more error cases, for the first processing rule and the second processing rule based on determining that the group of one or more values is applicable to both the first processing rule and the second processing rule.

6. The system of claim 1, wherein the one or more processors, to determine the set of possible values, are configured to:
determine a relationship between a first conditional variable, of the set of conditional variables, and a second conditional variable, of the set of conditional variables; and
determine a group of possible values for the second conditional variable based on the relationship between the first conditional variable and the second conditional variable.

7. The system of claim 1, wherein the one or more processors are further configured to:
divide the data file into a plurality of sub-files based on at least one conditional variable, of the set of conditional variables; and
wherein the one or more processors, to determine the set of possible values, are configured to:
determine a plurality of sets of possible values for the plurality of sub-files.

8. The system of claim 7, wherein the one or more processors, to evaluate the set of processing rules, are configured to:
evaluate a first subset of processing rules of a first sub-file, of the plurality of sub-files, in parallel with evaluating a second subset of processing rules of a second sub-file of the plurality of sub-files.

9. A non-transitory computer-readable medium storing a set of instructions, the set of instructions comprising:
one or more instructions that, when executed by one or more processors of a system, cause the system to:
receive a new processing rules for inclusion in a data file, wherein the data file includes a set of processing rules for processing a dataset;
extract a set of conditional variables from the set of processing rules included in the data file and the new processing rule;
determine a set of possible values for the set of conditional variables;
generate a set of test cases, wherein a test case, of the set of test cases, represents a combination of a plurality of values, of the set of possible values, for the set of conditional variables;
evaluate, using the set of test cases, the set of processing rules and the new processing rule to identify one or more error cases associated with the new processing rule; and
selectively add the new processing rule to the data file based on evaluating the set of processing rules.

10. The non-transitory computer-readable medium of claim 9, wherein the one or more instructions, when executed by the one or more processors, further cause the system to:
evaluate the dataset using the data file based on adding the new processing rule to the data file; and
transmit an output identifying a result of evaluating the dataset.

11. The non-transitory computer-readable medium of claim 9, wherein the one or more instructions, that cause the system to evaluate the set of processing rules and the new processing rule, cause the system to:
identify a combination of values, of the set of possible values, that is not applicable to any processing rule, of the set of processing rules and the new processing rule; and
detect an error case for the combination of values.

12. The non-transitory computer-readable medium of claim 9, wherein the one or more instructions, that cause the system to evaluate the set of processing rules and the new processing rule, cause the system to:
detect an error case, of the one or more error cases, relating to an ordering of the set of processing rules and the new processing rule.

13. The non-transitory computer-readable medium of claim 9, wherein the one or more instructions, that cause the system to evaluate the set of processing rules and the new processing rule, cause the system to:
detect an error case, of the one or more error cases, relating to a redundancy between the set of processing rules and the new processing rule.

14. The non-transitory computer-readable medium of claim 9, wherein the one or more instructions, that cause the system to evaluate the set of processing rules and the new processing rule, cause the system to:
evaluate the set of processing rules and the new processing rule based on a prioritization of the set of processing rules and the new processing rule.

15. The non-transitory computer-readable medium of claim 9, wherein the one or more instructions, that cause the system to determine the set of possible values, cause the system to:
determine a subset of possible values for each processing rule of the set of processing rules and the new processing rule;
generate a set of combinations of the subset of possible values; and
add the set of combinations to the set of possible values for the set of processing rules.

16. The non-transitory computer-readable medium of claim 9, wherein the one or more instructions, that cause the system to determine the set of possible values, cause the system to:
determine the set of possible values for the set of processing rules and the new processing rule;
generate a set of combinations of the set of possible values; and
add the set of combinations to the set of possible values.

17. A method, comprising:
receiving, by a rule evaluation system, a data file including a set of processing rules for processing a dataset;
extracting, by the rule evaluation system, a set of conditional variables from the set of processing rules included in the data file;
determining, by the rule evaluation system, a set of possible values for the set of conditional variables;
generating, by the rule evaluation system, a set of test cases, wherein a test case, of the set of test cases, represents a combination of a plurality of values, of the set of possible values, for the set of conditional variables;
evaluating, by the rule evaluation system and using the set of test cases, the set of processing rules to identify one or more error cases associated with one or more processing rules of the set of processing rules; and
providing, by the rule evaluation system, output identifying a result of evaluating the set of processing rules.

18. The method of claim 17, wherein providing the output comprises:
removing one or more processing rules, of the set of processing rules, from the data file to generate a new data file; and
transmitting the new data file.

19. The method of claim 17, wherein providing the output comprises:
executing a subset of processing rules, of the set of processing rules, on the dataset based on evaluating the set of processing rules; and
providing the output to identify the result of executing the subset of processing rules.

20. The method of claim 17, further comprising:
dividing the data file into a plurality of sub-files based on at least one conditional variable, of the set of conditional variables; and
wherein determining the set of possible values comprises:
determining a plurality of sets of possible values for the plurality of sub-files.
